(19) United States
(12) Patent Application Publication
(10) Pub. No.: US 2006/0279657 A1
(43) Pub. Date: Dec. 14, 2006

(54) Display control device and method and program

(75) Inventor: Kazuo Aoki, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/440,262

(22) Filed: May 23, 2006

(30) Foreign Application Priority Data
May 25, 2005 (JP) P2005-151880

(51) Int. Cl. H04N 11/00

(52) U.S. Cl. 348/468

(57) ABSTRACT

A display control device includes a display control unit which displays side by side a first program guide, the first program guide displaying information of programs to be broadcasted on respective channels in a predetermined time period, and a second program guide, the second program guide displaying information of programs to be broadcasted on a selected channel in respective time periods. When a channel selected by movement of a cursor on the first program guide is switched, the display control unit displays the second program guide after the channel is switched.

### CROSS-REFERENCE TO RELATED APPLICATIONS

The present application claims priority from Japanese Patent Application No. JP 2005-151880 filed on May 25, 2005, the disclosure of which is hereby incorporated by reference herein.

### BACKGROUND OF THE INVENTION

The present invention relates to a display control device, a display control method and a program and, in particular, to a display control device, a display control method and a program, with which a user can confirm an information of programs broadcasted in a time period other than a marked time period and programs broadcasted in a channel other than a marked channel.

The two-dimensional display has been known as a method for displaying a program guide. In the known two-dimensional display, a time axis and a channel axis are set in one direction and in a direction orthogonal to the one direction, respectively, and information of programs broadcasted in channels are displayed in positions corresponding to broadcasting times of the programs.

FIGS. 1 and 2 show examples of the program guide displayed in the two dimensional display, respectively.

In the example shown in FIG. 1, the time axis is set vertically and the channel axis is set laterally. Information of respective programs (program names) are displayed in positions corresponding to broadcasting times of the programs. In the example shown in FIG. 2, the channel axis is set vertically and the time axis is set laterally and information of the respective programs (program names) are displayed in positions Corresponding to the broadcasting times thereof.

With such program guide, a user is possible to confirm a program on any channel and in any time period.

Incidentally, though, according to the program guide displayed two-dimensionally, the user can confirm programs broadcasted on a plurality of channels in respective time periods on one display screen, display areas assigned to the respective programs are narrow and it is difficult to display information of each program in detail. For example, though, in information such as castings and outlines of programs in addition to titles and broadcasting times of the programs are included in EPG (Electronic Program Guide) data, which is basic information of the display of the program guide, it is difficult to display the information of EPG data.

In order to display more information of each program, for example, the display by time and the display by channel have been proposed as the display method of program guide other than the two dimentional display.

The display by time marks a certain time period such as one hour and displays a list of names and the like of programs to be broadcasted in respective channels in the marked time period. The display by channel marks a certain channel and displays a list of as names and the like of programs to be broadcasted in the certain channel. For example, the reference “DVD Recorder with Hard Disk “Sugoroku” EPG/Program Follow-up Recording” <http://www.sony.jp/products/Consumer/dvdrecorder/ products/rdr_hx100_hx90.html> discloses the display by time and the display by channel.

However, since the display by time marks a predetermined time such as one hour, it may be impossible for a user to confirm programs to be broadcasted in other time periods unless, for example, a switching operation of the marked time period is performed.

Since the display by channel marks a predetermined channel, it may be impossible for a user to confirm programs to be broadcasted on other channel unless, for example, a switching operation of the marked channel is performed.

### SUMMARY OF THE INVENTION

According to the present invention, a user is allowed to confirm information of programs to be broadcasted in time periods other than a selected time period and programs to be broadcasted on channels other than a selected channel.

According to an embodiment of the present invention, there is provided a display control unit that displays, side by side, a first program guide in which information of programs to be broadcasted on respective channels in a predetermined time period is displayed, and a second program guide in which information of programs to be broadcasted on a selected channel in respective time periods is displayed and, when a channel selected by movement of a cursor on the first program guide is switched, displays the second program guide after the channel is switched.

Further, when a time period selected on the second program guide is switched to another time period by the cursor, the display control unit displays the first program guide after the time period is switched.

When an instruction is given to display a program guide, the display control unit displays the first program guide and the second program guide side by side, the first program guide including a selected time, in which a channel watched by a user immediately before the selected time is selected by the cursor, and the second program guide including the channel watched by the user immediately before the selected time.

The display control unit displays, side by side, the first program guide in the predetermined time period and the second program guide in which information of programs to be broadcasted in the predetermined time period and information of programs to be broadcasted in a subsequent time period are displayed.

The display control unit displays, side by side, a first program guide and a second program guide by giving a wide display area to one of the first and second program guides in which a predetermined channel or a predetermined time period is selected by the cursor.

In an embodiment of the present invention, a first program guide, in which information of programs to be broadcasted on respective channels in a predetermined time period are displayed, and a program guide by channel, in which information of programs to be broadcasted on a selected channel in respective time periods are displayed, are displayed side by side and, when a channel selected by movement of a cursor on the program guide by time is switched, a program guide by channel after the channel is switched is displayed.

According to an embodiment of the present invention, it is also possible to confirm information of programs to be broadcasted in time periods other than the selected time period and programs to be broadcasted on channels other than the selected channel.

### BRIEF DESCRIPTION OF THE DRAWINGS

FIG. 1 shows an example of the two-dimensional display of a program guide;

FIG. 2 shows another example of the two-dimensional display of a program guide;

FIG. 3 is a block diagram showing an example of construction of a DTV according to an embodiment of the present invention;

FIG. 4 shows an example of display on a program guide screen;

FIG. 5 shows another example of display on a program guide screen;

FIG. 6 shows another example of display on a program guide screen;

FIG. 7 shows another example of display on a program guide screen;

FIG. 8 is a flowchart for explaining a display control processing of the DTV;

FIG. 9 shows another example of display on a program guide screen; and

FIG. 10 is a block diagram showing an example of construction of a personal computer.

### DETAILED DESCRIPTION

Before describing embodiments of the present invention, the correspondence between the invention and the embodiments described in this specification and the embodiment will be described in order to confirm that the embodiments supporting the invention defined in claims are described in the specification. When there are embodiments, which are described in the specification but not described as corresponding to the invention, it does not mean that such embodiments do not correspond to the invention. Conversely, when the embodiments are described in the specification as corresponding to the invention, it does not mean that the embodiments do not correspond to any invention other than the invention defined in the claims.

Further, the description of the specification does not describe all inventions of the present application. In other words, the description of the specification does not deny existence of inventions, which are not claimed, that is, may be divided from the present application or may be added to this application by correction.

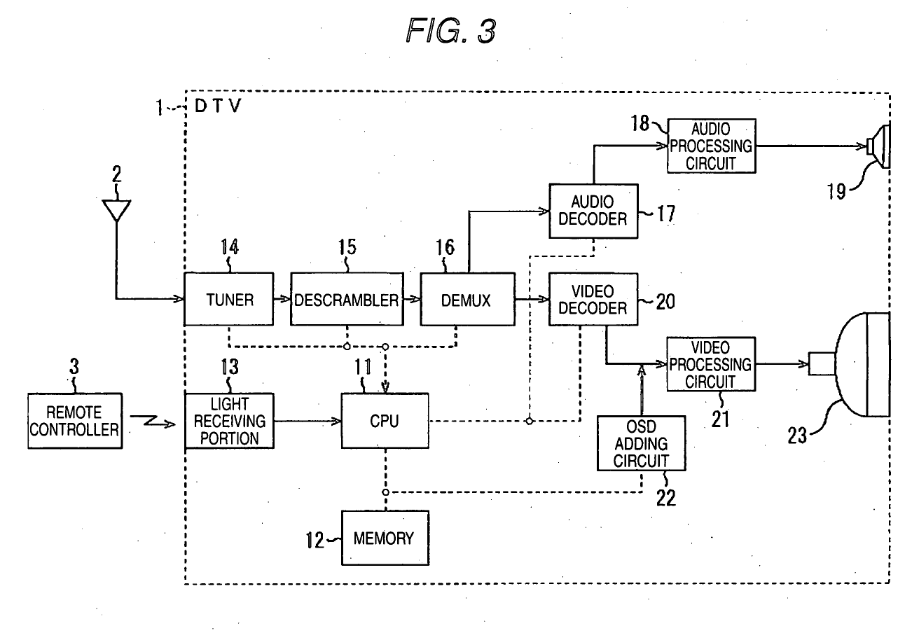

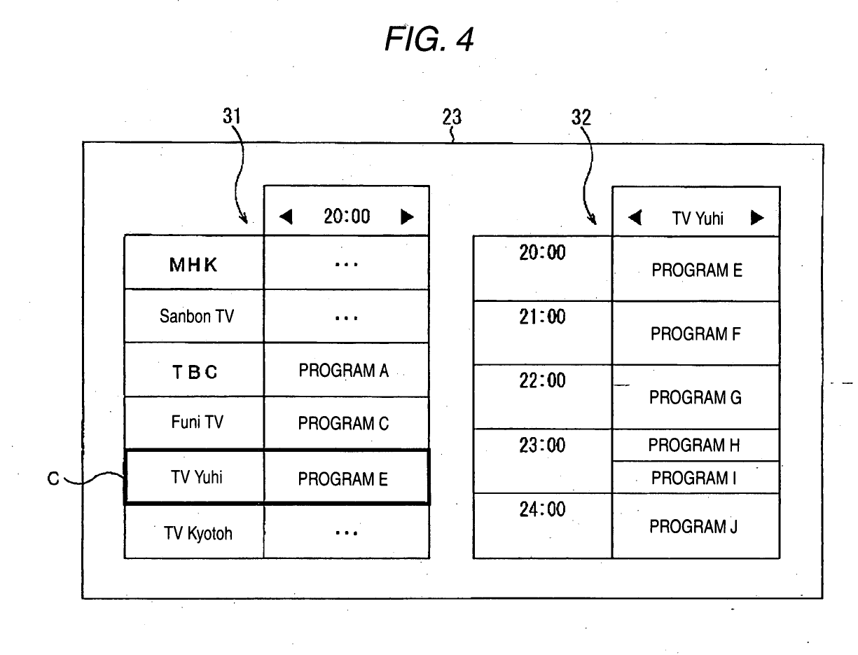

A display control device (for example, DTV1 shown in FIG. 3) according to an embodiment of the present invention includes a display control unit (for example, an OSD adding circuit 22 in FIG. 3). The display control unit displays, side by side, a first program guide (for example, a program guide by, hour 31 shown in FIG. 4) for orderly displaying information of programs to be broadcasted in channels in a marked predetermined time period and a second program guide (for example, a second program guide 32 in FIG. 4) for orderly displaying information of programs to be broadcasted in time periods in a marked channel. When a channel is switched by a movement of a cursor (for example, a cursor C shown in FIG. 4) on the program guide by time, the display control unit displays the program guide by channel of the switched channel.

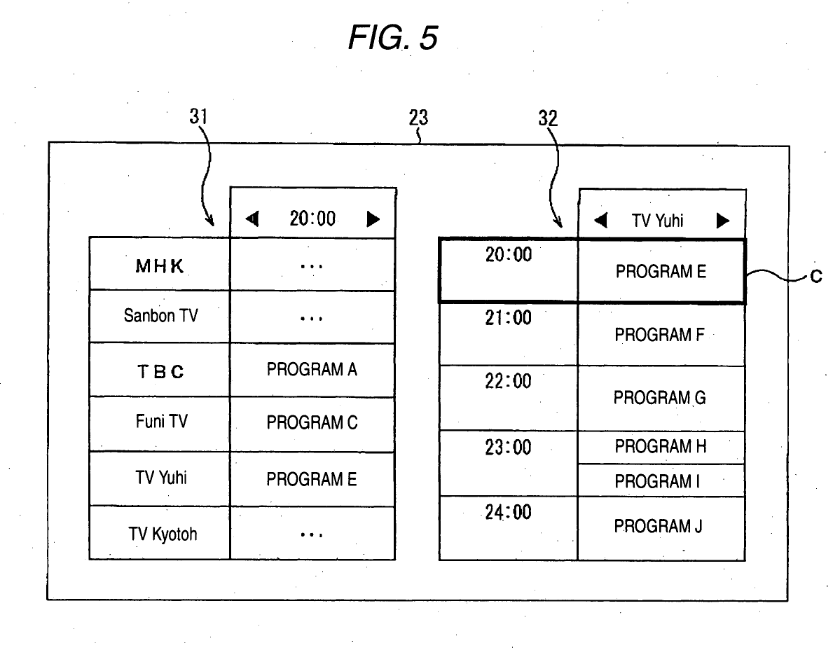

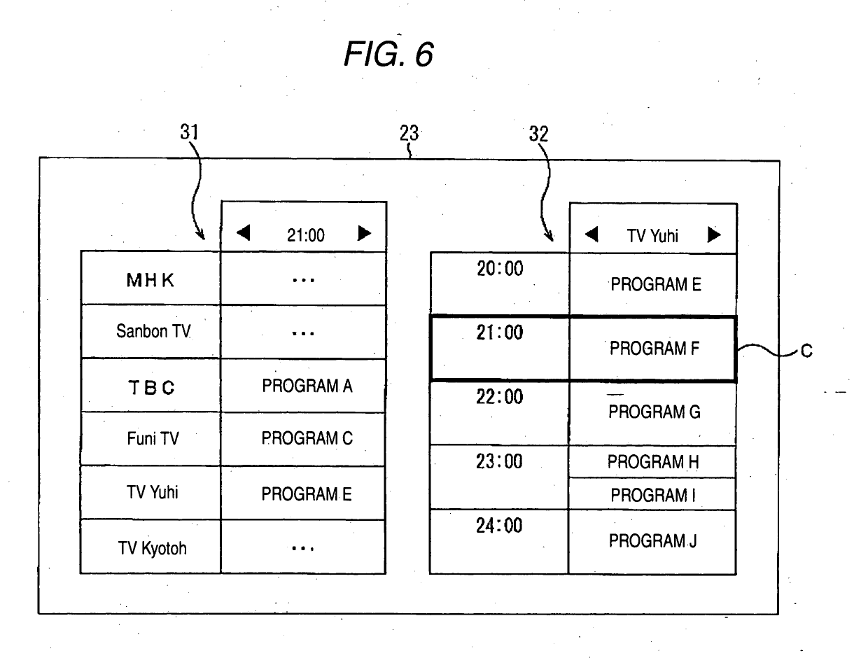

According to another embodiment of the present invention, the display control unit of the display control device displays, when the time period selected on the program guide by channel is switched by a movement of the cursor, the program guide by time of the time period after switched (for example, from a state shown in FIG. 5 to a state shown in FIG. 6).

The display control device according to a further embodiment of the present invention includes the display control unit orderly displays the program guide by hour in the predetermined time period (for example, time period “20:00” shown in FIG. 4) and the. program guide by channel in which information of programs to be broadcasted in the predetermined time period (for example, “program E” shown in FIG. 4) and information of programs (for example “program F”, “program-G”, “program H”, “program I” and “program J” shown in FIG. 4) to be broadcasted in other time periods (for example, a time period from “21:00” to “24:00” shown in FIG. 4) are displayed orderly.

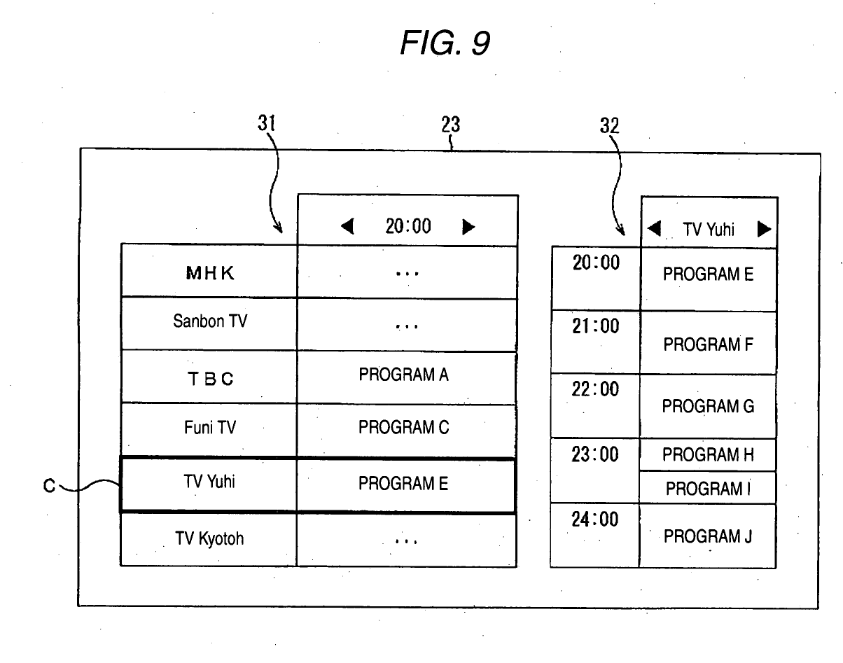

The display control device according to another embodiment of the present invention includes the display control unit orderly displays the program guide by hour and the program guide by channel by giving a wide area to one (for example, a program guide by hour 31 in a state shown in FIG. 9) of the program guide by hour and the program guide by channel, in which a predetermined channel or a predetermined time period is assigned by a cursor.

A display control method according to another embodiment of the present invention includes the display control step (for example, the step S5 in FIG. 9) of displaying, side by side, a first program guide, in which information of programs to be broadcasted in respective channels in a marked time period are orderly displayed, and a second program guide, in which information of programs to be broadcasted in a marked channel in respective time periods are orderly displayed and displaying, when a channel assigned by a movement of a cursor on the program guide by hour is switched, the program guide by channel of the channel after the switching.

An embodiment (only an example) of a program for executing a processing by a computer according to another embodiment of the present invention is similar to the display control method.

Now, the embodiments of the present invention will be described with reference to the drawings.

FIG. 3 is a block diagram showing an example of a construction of a DTV (Digital television) 1 according to an embodiment of the present invention.

A CPU (Central Processing Unit) 11 controls operations of the whole DTV 1 according to signals supplied from a light receiving portion 13 by executing a program stored in a memory 12.

Further, when a display of program guide is instructed by a user, the CPU 11 controls respective units to display a program guide on a display 23 on the basis of an EPG (Electronic Program Guide) supplied from a DEMUX 16. In the DTV 1, as described in detail later a first program guide and a second program guide are displayed side by side and the program guide displays are switched together with a movement of a cursor.

The light receiving portion 13 demodulates infrared ray from a remote controller 3 to output a signal corresponding to a user operation to the CPU 11.

A tuner 14 receives broadcasting signal from an antenna 2, demodulates the broadcasting signal and outputs a transport stream (TS) broadcasted on a predetermined channel to a descrambler 15 under the control of the CPU 11. Incidentally, the received broadcasting signal includes EPG, which is information of program to be broadcasted.

The descrambler 15 releases the scramble of the transport stream from the tuner 14 by a key for releasing the scramble generated using data stored in a CAS card, which is not shown. The transport stream, which is descrambled by the descrambler 15, is supplied to a DEMUX (demultiplexer) 16.

Under the control of the CPU 11, the DEMUX 16 extracts a predetermined stream from the transport stream supplied by the descrambler 15 and outputs the extracted stream (a packet constructing the stream) to an audio decoder 17 and a video decoder 20. Further, the DEMUX 16 outputs the EPG extracted from the transport stream to the CPU 11.

The audio decoder 17 decodes the audio data (audio packet) supplied from the DEMUX 16 and outputs the decoded audio data to an audio processing circuit 18.

The audio processing circuit 18 converts the digital audio data supplied from the audio decoder 17 to an analog data and performs amplifying processing and the analog data is outputted from a loud speaker 19.

The video decoder 20 decodes the video data (video packet) supplied from the DEMUX 16 and outputs the decoded video data to a video processing circuit 21.

The video processing circuit 21 displays an image of contents on a display 23 by performing a predetermined image processing and a D/A conversion, etc., of the video data supplied from the video decoder 20. Further, the video processing circuit 21 displays a predetermined image on the display 23 on the basis of the video data supplied from an OSD (On Screen Display) adding circuit 22.

The OSD adding circuit 22 generates video data of the image to be displayed on the display 23 under control of the CPU 11 and the video data thus generated is outputted to the video processing circuit 21. The video data for displaying, for example, a program guide is generated by the OSD adding circuit 22 and outputted to the video image processing circuit 21.

The program guide displayed by the DTV 1 having the described construction will be described. FIG. 4 shows an example of the display by the DTV 1.

The display screen shown in FIG. 4 is displayed when a user instructs a display of program-guide by operating the remote controller 3 or the like.

As shown in FIG. 4, the program guide by hour 31 is displayed on, for example, a left side of the program guide displayed on the DTV 1 and the program guide by channel 32 is displayed on a right side thereof.

The program guide by hour 31 displays a list of names, etc., of programs to be broadcasted in respective channels in a marked certain time period, for example, 1 hour. In the example shown in FIG. 4, the time period “20:00” is marked and program names “. . . ”, “. . . ”, “program A”, “program C”, “program E” and “. . . ”, which are to be broadcasted in channels of respective “MHK”, “Sanbon TV”, “TBC”, “Funi TV”, “TV Yuhi” and “TV Kyotoh”, are displayed vertically as information of programs to be broadcasted by the channels.

A time at which the display of the program guide is instructed by the user is included in the time period “20:00”, which is marked in the program by hour 31.

Further, in the example shown in FIG. 4, “TV Yuhi” (information column of programs to be broadcasted on the channel of “TV Yuhi”) is selected among the channels displayed in the program guide by hour 31 by the cursor C. The “TV Yuhi” is a channel, which is watched by the user immediately before the user instructs the display of the program guide.

The user can select one of the channels displayed in the program guide by hour 31 by moving the cursor C by pressing an upward or a downward button provided on the remote controller 3.

When the program (in the channel column in the program guide by hour 31 and in a time period column in the program guide by channel 32) is selected and further a predetermined operation is to be performed, a list (menu) of operations capable of performing with respect to the program is displayed. The user can watch a program or set a video tape setting by selecting a program from the menu when the program is to be broadcasted.

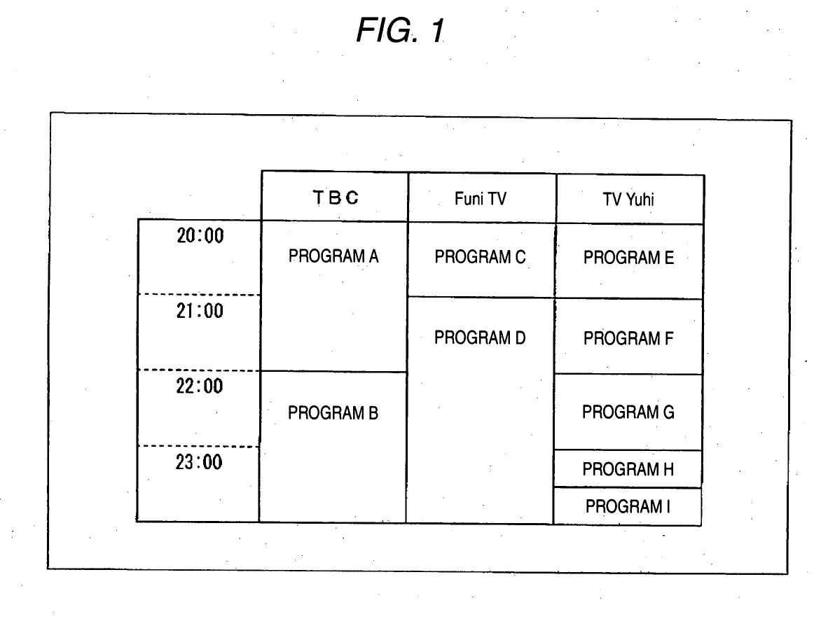

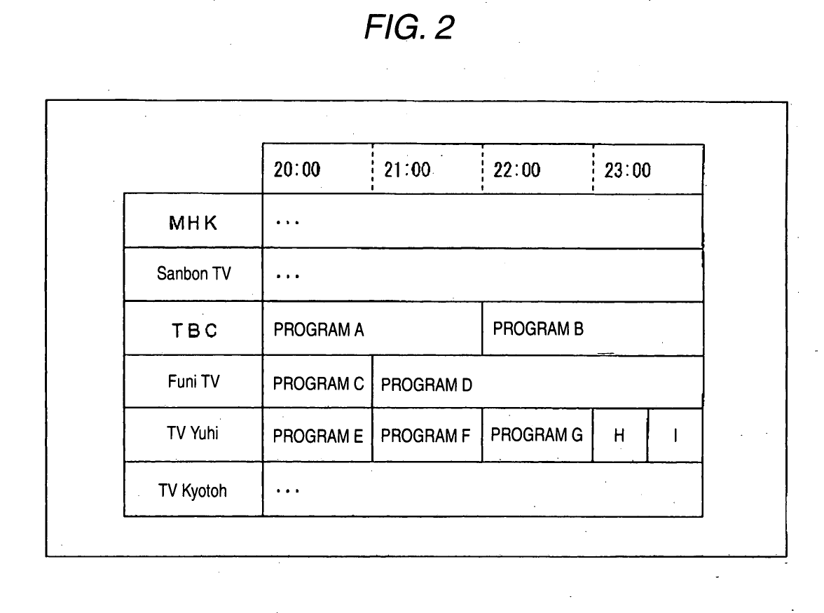

Incidentally, the example shown in FIG. 4 corresponds to the program guides shown in FIGS. 1 and 2 and names of programs broadcasted by respective channels are practically displayed in positions “. . . ” in which program names are abbreviated. Though only names of the programs are displayed in the respective columns as program information, information such as a casting and an outline of each program, which are contained in the EPG, are also displayed.

On the other hand, the program guide by channel 32 is for a case where a certain channel is marked and a list of names of programs broadcasted on the certain channel in respective time periods is displayed. In the example shown in FIG. 4, the “TV Yuhi” is marked.

That is, a channel selected by the cursor from the program guide by hour 31 on the left side is marked and information of programs broadcasted on that channel in respective time periods are displayed in the program guide by channel 32. In a default state (a state immediately after the user instructs the display of the program guide or a state where the user selects a channel from the program guide by hour 31), the program information displayed in the program guide by channel 32 includes programs to be broadcasted in time periods, with the program to be broadcasted in the marked time period in the left side program guide by hour 31 being a top.

In the example shown in FIG. 4, the names of programs arranged vertically includes the program name “program E” of the program to be broadcasted by the “TV Yuhi” in the time period “20:00” marked in the program guide by hour 31 and the subsequent program names “program F”, “program G”, “program H”, “program I” and “program J”, which are to be broadcasted in time periods “21:00” to “24:00”, with the “program E” being the top.

According to the display screen of such a program guide, the user can confirm information of programs to be broadcasted by respective channels in a certain time period by looking at the displayed left side program guide by hour 31. Further, the user can confirm information of programs to be broadcasted in respective time periods in a certain channel pointed by the cursor C in the left side program guide by hour 31 by looking at the right side program guide by channel 32.

Further, since the number of time periods and the number of channels, which are displayed all at once, are small compared with those of the two-dimensional program guide shown in FIGS. 1 and 2, it is possible to hold an area for displaying the program information wider.

FIG. 5 shows an example of the program guide displayed on the display screen when, in the state shown in FIG. 4, a rightward button provided on the remote controller 3 is pressing by the user.

In FIG. 5, the cursor C displayed on the program guide by hour 31 is moved onto the right side program guide by channel 32 such that the top time period “20:00” is selected. The user can select one of the time periods displayed on the program guide by channel 32 by moving the cursor C by pressing the upward or the downward button provided on the remote controller 3.

FIG. 6 shows an example of the program guide displayed on the display screen when, in the state shown in FIG. 5, the downward button provided on the remote controller 3 is pressed by the user.

In FIG. 6, the cursor C pointed to “20:00” on the program guide by channel 32 is moved onto the next time period “21:00” such that the time period “21:00” is selected.

When the time period to be selected by the cursor C in the program guide by channel 32 is switched, the time period marked on the program guide by hour 31 is switched to another, so that names of the programs to be broadcasted in the respective channels in the time period “21:00” which is the time period after the switching are displayed on the program guide by hour 31 as shown in FIG. 6. In FIG. 6, the program names “. . . ”, “. . . ”, “program A”, “program D”, “program F” and “. . . ” are displayed.

By switching the displays on the program guide by hour 31 and the program guide by channel 32 in this manner, the user can confirm on the program guide by hour 31 information of programs to be broadcasted by channels other than the marked channel on the program guide by channel 32 in the time period selected by moving the cursor C on the program guide by channel 32.

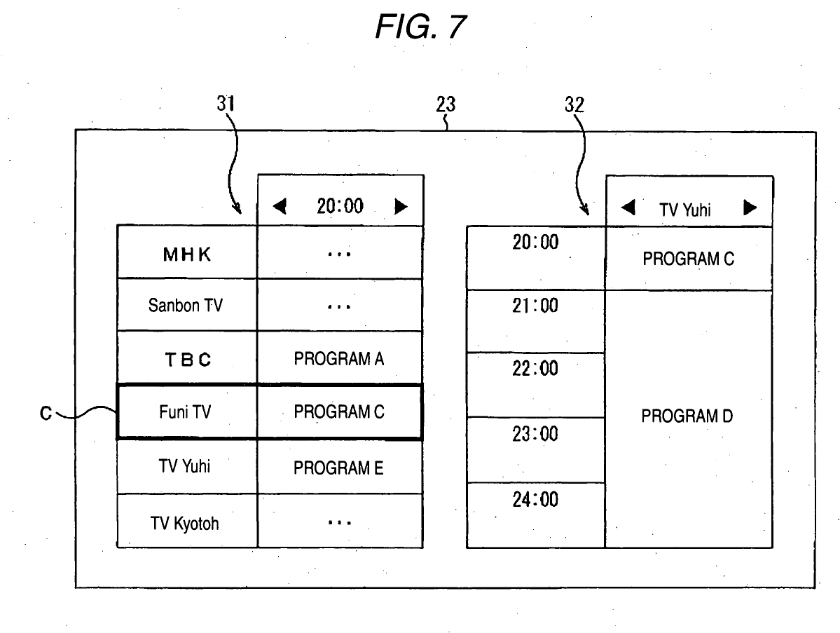

FIG. 7 shows an example of the program guide displayed on the display screen when, in the state shown in FIG. 4, the upward button provided on the remote controller 3 is pressed by the user.

In this case, the cursor C pointing “TV Yuhi” in the program guide by hour 31 is moved to “Funi TV”, which is next to “TV Yuhi” (has channel number smaller than that of “TV Yuhi” by 1), to select “Funi TV”, as shown in FIG. 7.

When the channel to be marked is switched by the cursor C in the program guide by hour 31, the channel marked in the program guide by channel 32 is switched, so that the names of programs to be broadcasted in the selected channel “Funi TV” in respective time periods are displayed on the program guide by channel 32 as shown in FIG. 7. In the example shown in FIG. 7, the display of the program names “program C” and “program D” to be broadcasted in a time from “20:00” to “24:00” are displayed.

By switching the display on the program guide by hour 31 and the program guide by channel 32 in this manner, the user can confirm on the program guide by channel 32 information of programs broadcasted in the time periods other than the marked time period on the program guide by hour 31 by the channel selected by moving the cursor C on the program guide by hour 31.

Incidentally, the user can switch the time period marked in the program guide by hour 31 to a time period before or after the marked time period by moving the cursor C in “20:00” of the program guide by hour 31 shown in FIG. 4 and pressing the leftward or the rightward button of the remote controller 3. Triangle marks positioned in a left and right sides of “20:00” in FIG. 4 shows this switching.

When the marked time period is switched by the user, the switched time period and information of programs broadcasted by the respective channels are shown in the program guide by hour 31.

Further, the user can switch the channel marked in the program guide by channel 32 to a channel adjacent to the marked channel (a channel having adjacent number) by moving the cursor C in for example, “TV Yuhi” of the program guide by channel 32 shown in FIG. 4 and pressing the leftward or the rightward button of the remote controller 3. Triangle marks positioned in a left and right sides of “TV Yuhi” in FIG. 4 shows this switching.

When the marked channel is switched by the user, the switched channel and information of programs broadcasted in the respective time periods are shown in the program guide by channel 32.

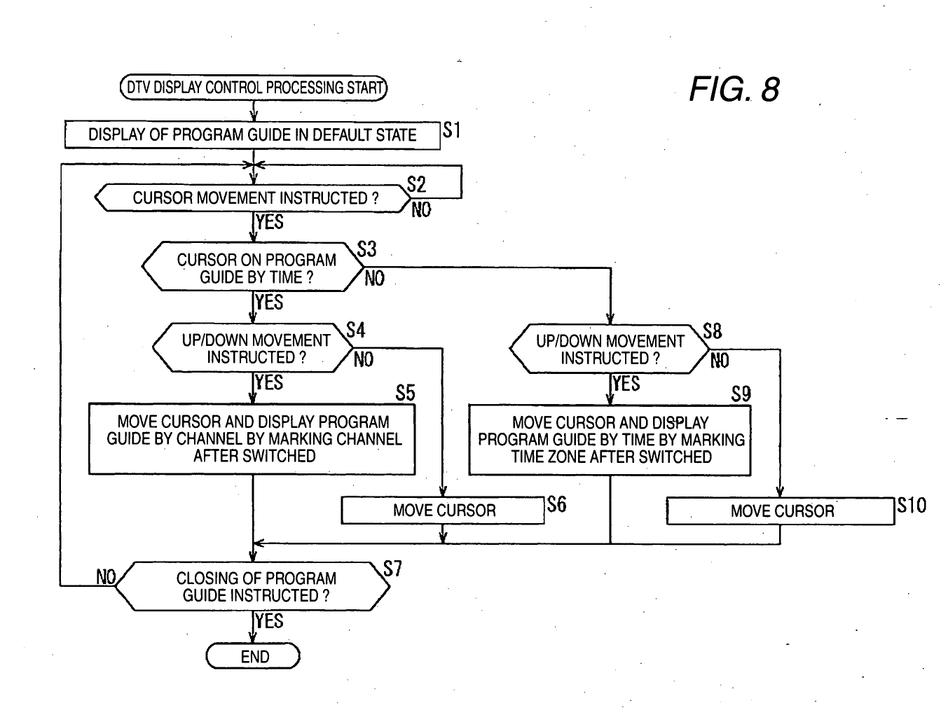

Now, a display control processing of the DTV 1 for performing the above described screen display will be described with reference to a flowchart shown in FIG. 8.

When the user instructs a display of the program guide on the display screen, the CPU 11 displays the program guide screen in the default state on the display 23 by controlling the OSD adding circuit 22 in the step S1. That is, in this case, the program guide, in which the program guide by hour 31 marking a time period including a time when the user instructs the program guide display and the program guide by channel 32 marking a channel watched by the user immediately before the user instructs the program guide display are displayed side by side, is displayed as shown in FIG. 4.

In the step S2, the CPU 11 determines, on the basis of the signal supplied from the light receiving portion 13, whether or not a movement of the cursor C is instructed and waits for until it is determined that the movement of cursor is instructed.

When the CPU 11 determines in the step S2 that the movement of the cursor C is instructed, the processing is shifted to the step S3 in which it is determined whether or not the cursor C is displayed on the program guide by hour 31.

In the step S3, when the CPU 11 determines that, for example, the cursor C is displayed on the program guide by hour 31 as shown in FIG. 4, the processing is shifted to the step S4 and the CPU 11 determines whether or not the instructed movement of the cursor C is the upward or downward.

in the step S4, when the CPU 11 determines the. instructed movement of the cursor C in the upward or downward direction, the processing is shifted to the step S5 and the CPU 11 moves the cursor C according to the instruction of the user to switch the channel to a selected channel and displays the program guide by channel 32 marking the selected channel by controlling the OSD adding circuit 22. That is, when the upward movement of the cursor C is instructed in the state shown in FIG. 4, the program guide shown in FIG. 7 is displayed on the screen.

For example, when it is determined in the step S4 that the upward or downward movement is not instructed since the rightward movement is instructed, the processing is shifted to the step S6 and the CPU 11 moves the cursor C according to the instruction of the user by controlling the OSD adding circuit 22. In this case, the program guide display is switched from the state shown in FIG. 4 to the state shown in FIG. 5.

After the display is switched in the step S5 or the step S6, the CPU 11 determines in the step S7 whether or not a closing of the program guide display is instructed. When it is determined that the closing of the program guide display is not instructed, the processing is returned to the step S2 and the processing in the subsequent steps is executed.

On the other hand, when it is determined in the step S3 that the cursor C is not displayed on the program guide by hour 31, that is, the cursor C is displayed on the program guide by channel 32, the processing is shifted to the step S8 and it is determined whether or not the upward or downward movement is instructed.

When the CPU 11 is determined in the step S8 that the upward or downward movement is instructed, the processing is shifted to the step S9 in which the CPU 11 controls the OSD adding circuit 22 to move the cursor C according to the instruction of the user to thereby switch the marked time period and display the program guide by hour 31 marking the time period after switched. That is, when, for example, the downward movement of the cursor C is instructed in the state shown in FIG. 5, the program guide in the state shown in FIG. 6 is displayed.

For example, when it is determined in the step S8 that the movement in the upward or downward direction is not instructed since the leftward movement is instructed, the processing is shifted to the step S10 and the CPU 11 controls the OSD adding circuit 22 to move the cursor C according to the instruction of the user. In this case, the program guide in the state shown in FIG. 5 is switched to the program guide shown in FIG. 4.

After the display is switched in the step S9 or the step S10, the processing is shifted to the step S7 and the CPU 11 determines whether or not the closing of the program guide screen is instructed. When the CPU 11 determines in the step S7 that the closing of the program guide is not instructed, the processing is returned to the step S2 and the processing in the subsequent steps is executed. On the other hand, it is determined that the closing of the program guide display is instructed, the processing is ended.

With the above mentioned processing, the user can confirm, from the program guide by channel 32, the information of programs broadcasted in other time period than the time period marked in the program guide by hour 31 and can confirm, and from the program guide by time 31, the information of programs broadcasted in other channels than the channel marked in the program guide by channel 32.

In the described embodiment, the program guide by hour 31 and the program guide by channel 32 are displayed side by side in substantially the same areas. It may be possible to give a wider display area to the program guide, to which the cursor C is pointed, compared with the display area of the program guide, to which the cursor C is not pointed, and to switch an amount of information of the programs displayed therein.

FIG. 9 shows an example of a program guide display screen in which the sizes of the program guide by hour 31 and the program guide by channel 32 are made different depending upon whether or not the cursor C is pointed.

In the example shown in FIG. 9, the cursor C is pointed to the program guide by hour 31 and the area of the program guide by hour 31 is wider than that of the program guide by channel 32 and the program guide by hour 31 is shown expanded. Due to the expanded area of the program guide by hour 31, it is possible to display more information of programs broadcasted by the respective channels in the marked time period than information of the programs displayed in the program guide by channel 32.

For example, when the user operates the cursor so as to move C onto the program guide,by channel 32 in this state, the cursor C moves onto the program guide by channel 32 and the wide display area is given to the program guide by channel 32, so that the program guide by channel 32 is displayed larger than the program guide by hour 31. Due to the wide display area, it is possible to display more information of programs broadcasted by the respective time periods in the marked channel than information of the programs displayed in the program guide by hour 31.

The program guide pointed by the cursor C may be watched by the user frequently compared with the program guide to which the cursor C is not pointed. Therefore, by switching the display size correspondingly to the pointing of the cursor C, it is possible to efficiently display the program guide.

Though, in the described embodiment, the program guides such as shown in FIGS. 4 to 7 and 9 are displayed by the DTV 1, it is possible to display them by a recording device such as a hard disk recorder or a DVD recorder or various devices, which handle EPG.

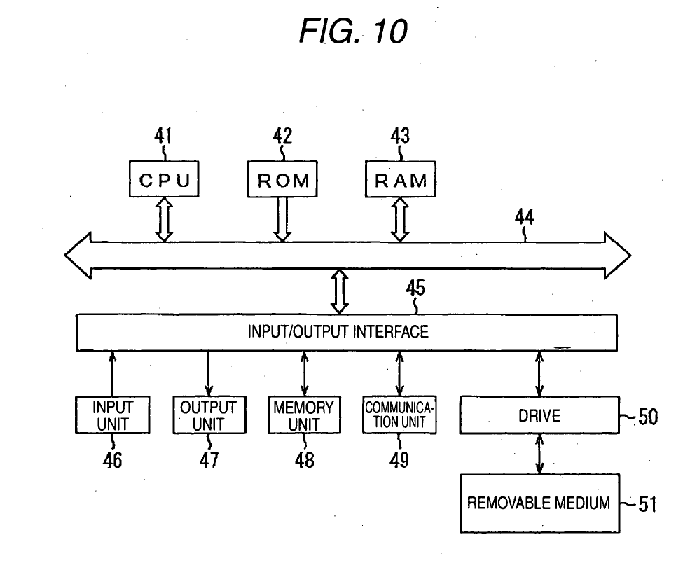

Though the series of the processing described hereinbefore may be executed by hardware, it can be executed by software. In such case, a device for executing the software is constructed by a personal computer such as shown in FIG. 10.

In FIG. 10, a CPU 41 executes various processing according to a program stored in a ROM (Read Only Memory) 42 or a program loaded in a RAM (Random Access Memory) 43 from a memory unit 48. Data, which is necessary in executing the various processing by the CPU 41, is appropriately stored in the RAM 43.

The CPU 41, the ROM 42 and the RAM 43 are connected each other by a bus 44. An input/output interface 45 is also connected to the bus 44.

An input unit 46 having a key board and a mouse, an output unit 47 including a display having a LCD (Liquid Crystal Display) and a loudspeaker, a memory unit 48 havigng a hard disk and a communication unit 49 for performing a communication processing through a network 20 are connected to the input/output interface 45.

A drive 50 is connected to the input/output interface 45 on demand. A removable media 51 such as a magnetic disk, an optical disk, an opto-magnetic disk or a semiconductor memory is connected to the drive 50 appropriately and a computer program read out from the removable media is installed in the memory unit 48 on demand.

In the case where the series processing is executed by software, a program constituting the software is installed in a computer assembled in a dedicated hardware or a general-purpose personal computer capable of executing various functions by installing various programs from a network or a recording medium.

The recording medium is constructed with the removable media 51 provided separately from the device body to give the user the program and including a magnetic disk (including a flexible disk), an optical disk (CD-ROM (Compact Disk-Read Only Memory)), a DVD (including Digital Versatile Disk), an opto-magnetic disk (MD (registered trademark) (including Mini-Disk)) or a semiconductor memory, in which the program is stored, as shown in FIG. 10 or with the ROM 42, which is assembled in the device body and stores the program given by the user, and the hard disk included in the memory unit 48.

Incidentally, the respective steps described in this specification include the processing, which is performed in the described in time series sequence and the processing, which is not always executed in time series and is executed in parallel or individually.

It should be understood by those skilled in the art that various modifications, combinations, sub-combinations and alterations may occur depending on design requirements and other factors insofar as they are within the scope of the appended claims or the equivalents thereof.

1. A display control device, comprising:
a display control unit operable
to display side by side a first program guide by time, the first program guide displaying information of programs to be broadcasted on respective channels in a predetermined time period, and a second program guide by channel, the second program guide displaying information of programs to be broadcasted on a selected channel in respective time periods, and
when a channel selected by movement of a cursor on the first program guide is switched, to display the second program guide after the channel is switched.

2. A display control device as claimed in claim 1, wherein, when a time period selected by movement of a cursor on the second program guide is switched, the display control unit is operable to display the first program guide after the time period is switched.

3. A display control device as claimed in claim 1, wherein, when an instruction is given to display a program guide, the display control unit displays the first program guide and the second program guide side by side, the first program guide including a time at which the instruction is given to display the program guide and in which a channel watched by a user just before the instruction to display the program guide is given is selected by a cursor, and the second program guide including the channel watched by the user immediately before the instruction is given to display the program guide.

4. A display control device as claimed in claim 1, wherein the display control unit displays, side by side, the first program guide in the predetermined time period and the second program guide in which information of programs to be broadcasted in the predetermined time period and information of programs to be broadcasted in time periods other than the predetermined time period are displayed.

5. A display control device as claimed in claim 1, wherein the display control unit displays, side by side, the first program guide and the second program guide by giving a wide display area to one of the first and second program guides, in which a predetermined channel or a predetermined time period is selected by a cursor.

6. A display control method, comprising:
displaying, side by side, a first program guide and a second program guide, the first program guide displaying information of programs to be broadcasted on respective channels in a predetermined time period, and the second program guide displaying information of programs to be broadcasted on a selected channel in respective time periods; and
when a channel selected by movement of a cursor on the first program guide is switched, displaying the second program guide after the channel is switched.

7. A program for executing a display control process by a computer, the process comprising:
displaying, side by side, a first program guide and a second program guide, the first program guide displaying information of programs to be broadcasted on respective channels in a predetermined time period, and the second program guide displaying information of programs to be broadcasted on a selected channel in respective time periods; and
when a channel selected by movement of a cursor on the first program guide is switched, displaying the second program guide after the channel is switched.
